(19) United States
(12) Patent Application Publication
(10) Pub. No.: US 2018/0278498 A1
(43) Pub. Date: Sep. 27, 2018

(54) PROCESS REPRESENTATION FOR PROCESS-LEVEL NETWORK SEGMENTATION

(71) Applicant: CISCO TECHNOLOGY, INC., San Jose, CA (US)

(72) Inventors: Weifei Zeng, Sunnyvale, CA (US); Ali Parandehgheibi, Sunnyvale, CA (US); Vimal Jeyakumar, Sunnyvale, CA (US); Omid Madani, San Carlos, CA (US); Navindra Yadav, Cupertino, CA (US)

(21) Appl. No.: 15/467,814

(22) Filed: Mar. 23, 2017

(51) Int. Cl. H04L 12/26

(52) U.S. Cl. CPC H04L 43/045; G06F 3/0482

(57) ABSTRACT

A application and network analytics platform can capture telemetry (e.g., flow data, server data, process data, user data, policy data, etc.) within a network. The application and network analytics platform can determine flows between servers (physical and virtual servers), server configuration information, and the processes that generated the flows from the telemetry. The application and network analytics platform can compute feature vectors for the processes. The application and network analytics platform can utilize the feature vectors to assess various degrees of functional similarity among the processes. These relationships can form a hierarchical graph providing different application perspectives, from a coarse representation in which the entire data center can be a “root application” to a fine representation in which it may be possible to view the individual processes running on each server.

### TECHNICAL FIELD

The subject matter of this disclosure relates in general to the field of computer networks, and more specifically for segmenting a network at the level of processes running within the network.

### BACKGROUND

Network segmentation traditionally involved dividing an enterprise network into several sub-networks (“subnets”) and establishing policies on how the enterprise's computers (e.g., servers, workstations, desktops, laptops, etc.) within each subnet may interact with one another and with a larger network (e.g., a wide-area network (WAN) such as a global enterprise network or the Internet). Network administrators typically segmented a conventional enterprise network on an individual host-by-host basis in which each host represented a single computer associated with a unique network address. The advent of hardware virtualization and related technologies (e.g., desktop virtualization, operating system virtualization, containerization, etc.) enabled multiple virtual entities each with their own network address to reside on a single physical machine. This development, in which multiple computing entities could exist on the same physical host yet have different network and security requirements, required a different approach towards network segmentation-microsegmentation. In microsegmentation, the network may enforce policy within the hypervisor, container orchestrator, or other virtual entity manager. But the increasing complexity of enterprise networks, such as environments in which physical or bare metal servers interoperate with virtual entities or hybrid clouds that deploy applications using the enterprise's computing resources in combination with public cloud providers' computing resources, necessitates even more granular segmentation of a network.

### BRIEF DESCRIPTION OF THE FIGURES

FIG. 1 illustrates an example of a application and network analytics platform for providing process-level network segmentation in accordance with an embodiment;

FIG. 2 illustrates an example of a forwarding pipeline of an application-specific integrated circuit (ASIC) of a network device in accordance with an embodiment;

FIG. 3 illustrates an example of an enforcement engine in accordance with an embodiment;

FIG. 4 illustrates an example method for generating an application dependency map (ADM) in accordance with an embodiment;

FIG. 5 illustrates an example of a first graphical user interface for an application and network analytics platform in accordance with an embodiment;

FIG. 6 illustrates an example of a second graphical user interface for an application and network analytics platform in accordance with an embodiment; and

FIG. 7A and FIG. 7B illustrate examples of systems in accordance with some embodiments.

### DESCRIPTION OF EXAMPLE EMBODIMENTS

### Overview

An application and network analytics platform can capture telemetry telemetry (e.g., flow data, server data, process data, user data, policy data, etc.) within a network. The application and network analytics platform can determine flows between servers (physical and virtual servers), server configuration information, and the processes that generated the flows from the telemetry. The application and network analytics platform can compute feature vectors for the processes (i.e., process representations). The application and network analytics platform can utilize the feature vectors to assess various degrees of functional similarity among the processes. These relationships can form a hierarchical graph providing different application perspectives, from a coarse representation in which the entire data center can be a “root application” to a finer representation in which it may be possible to view the individual processes running on each server.

### Description

Network segmentation at the process level (i.e., application segmentation) can increase network security and efficiency by limiting exposure of the network to various granular units of computing in the data center, such as applications, processes, or other granularities. One consideration for implementing process-level network segmentation is determining how to represent processes in a manner that is comprehensible to users yet detailed enough to meaningfully differentiate one process from another. A process is associated with a number of different characteristics or features, such as an IP address, hostname, process identifier, command string, etc. Among these features, the command string may convey certain useful information about the functional aspects of the process. For example, the command string can include the name of the executable files and/or scripts of the process and the parameters/arguments setting forth a particular manner of invoking the process. However, when observing network activity in a data center, a user is not necessarily interested in a specific process and its parameters/arguments. Instead, the user is more likely seeking a general overview of the processes in the data center that perform the same underlying functions despite possibly different configurations. For instance, the same Java® program running with memory sizes of 8 GB and 16 GB may have slightly different command strings because of the differences in the memory size specifications but they may otherwise be functionally equivalent. In this sense, many parts of the command string may constitute “noise” and/or redundancies that may not be pertinent to the basic functionalities of the process. This noise and these redundancies may obscure a functional view of the processes running in the data center. Various embodiments involve generating succinct, meaningful, and informative representations of processes from their command strings to provide a better view and understanding of the processes running in the network.

Another consideration for implementing process-level network segmentation is how to represent each process in a graph representation. One choice is to have each process represent a node of the graph. However, such a graph would be immense for a typical enterprise network and difficult for users to interact with because of its size and complexity. In addition, functionally equivalent nodes are likely to be scattered across different parts of the graph. On the other hand, if the choice for nodes of the graph is too coarse, such as in the case where each node of the graph represents an individual server in the network, the resulting graph may not be able to provide sufficient visibility for multiple processes performing different functions on the same host. Various embodiments involve generating one or more graph representations of processes running in a network to overcome these and other deficiencies of conventional networks.

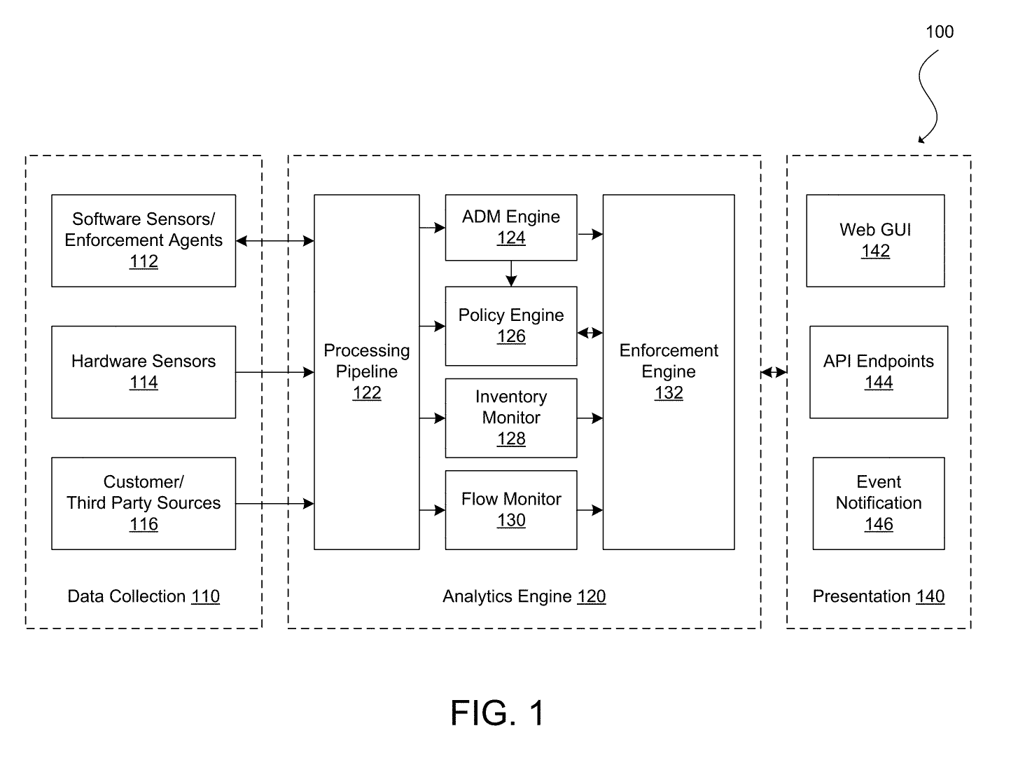

FIG. 1 illustrates an example of an application and network analytics platform 100 in accordance with an embodiment. Tetration Analytics™ provided by Cisco Systems®, Inc. of San Jose Calif. is an example implementation of the application and network analytics platform 100. However, one skilled in the art will understand that FIG. 1 (and generally any system discussed in this disclosure) is but one possible embodiment of an application and network analytics platform and that other embodiments can include additional, fewer, or alternative components arranged in similar or alternative orders, or in parallel, unless otherwise stated. In the example of FIG. 1, the application and network analytics platform 100 includes a data collection layer 110, an analytics engine 120, and a presentation layer 140.

The data collection layer 110 may include software sensors 112, hardware sensors 114, and customer/third party data sources 116. The software sensors 112 can run within servers of a network, such as physical or bare-metal servers; hypervisors, virtual machine monitors, container orchestrators, or other virtual entity managers; virtual machines, containers, or other virtual entities. The hardware sensors 114 can reside on the application-specific integrated circuits (ASICs) of switches, routers, or other network devices (e.g., packet capture (pcap) appliances such as a standalone packet monitor, a device connected to a network device's monitoring port, a device connected in series along a main trunk of a data center, or similar device). The software sensors 112 can capture telemetry from servers (e.g., flow data, server data, process data, user data, policy data, etc.) and the hardware sensors 114 can capture network telemetry (e.g., flow data) from network devices, and send the telemetry to the analytics engine 120 for further processing. For example, the software sensors 112 can sniff packets sent over their hosts' physical or virtual network interface cards (NICs), or individual processes on each server can report the telemetry to the software sensors 112. The hardware sensors 114 can capture network telemetry at line rate from all ports of the network devices hosting the hardware sensors.

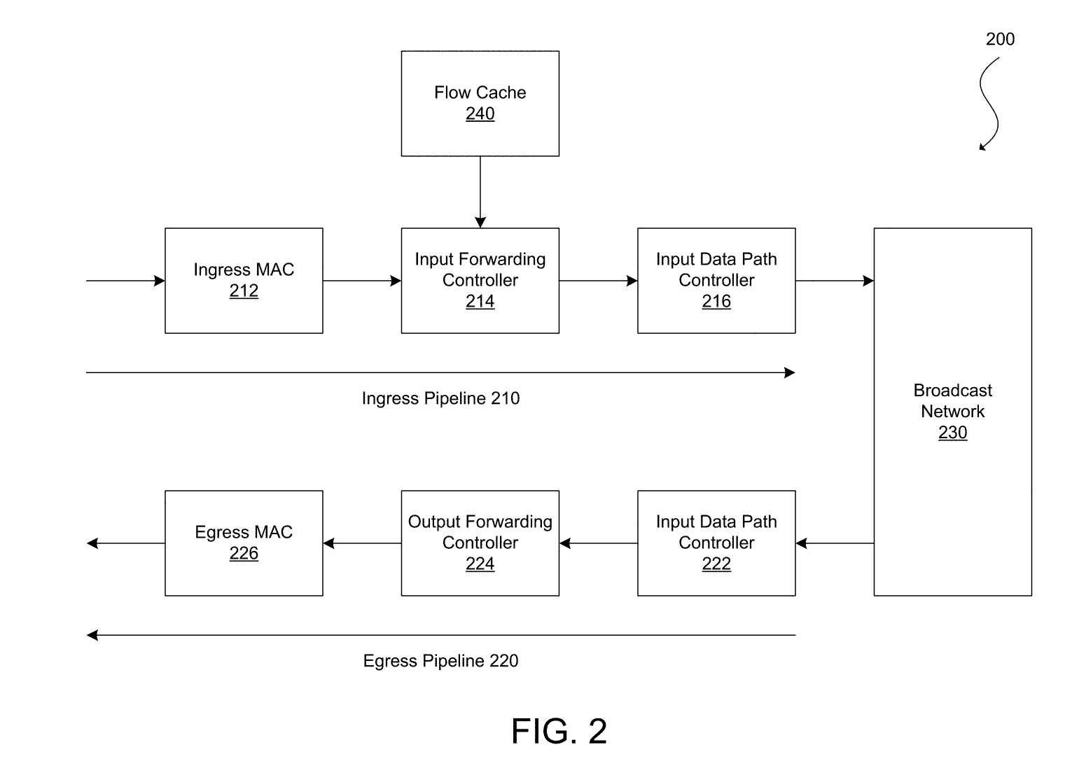

FIG. 2 illustrates an example of a unicast forwarding pipeline 200 of an ASIC for a network device that can capture network telemetry at line rate with minimal impact on the CPU. In some embodiments, one or more network devices may incorporate the Cisco® ASE2 or ASE3 ASICs for implementing the forwarding pipeline 200. For example, certain embodiments include one or more Cisco Nexus® 9000 Series Switches provided by Cisco Systems® that utilize the ASE2 or ASE3 ASICs or equivalent ASICs. The ASICs may have multiple slices (e.g., the ASE2 and ASE3 have six slices and two slices, respectively) in which each slice represents a switching subsystem with both an ingress forwarding pipeline 210 and an egress forwarding pipeline 220. The ingress forwarding pipeline 210 can include an input/output (I/O) component, ingress MAC 212; an input forwarding controller 214; and an input data path controller 216. The egress forwarding pipeline 220 can include an output data path controller 222, an output forwarding controller 224, and an I/O component, egress MAC 226. The slices may connect to a broadcast network 230 that can provide point-to-multipoint connections from each slice and all-to-all connectivity between slices. The broadcast network 230 can provide enough bandwidth to support full-line-rate forwarding between all slices concurrently. When a packet enters a network device, the packet goes through the ingress forwarding pipeline 210 of the slice on which the port of the ingress MAC 212 resides, traverses the broadcast network 230 to get onto the egress slice, and then goes through the egress forwarding pipeline 220 of the egress slice. The input forwarding controller 214 can receive the packet from the port of the ingress MAC 212, parse the packet headers, and perform a series of lookups to determine whether to forward the packet and how to forward the packet to its intended destination. The input forwarding controller 214 can also generate instructions for the input data path controller 216 to store and queue the packet. In some embodiments, the network device may be a cut-through switch such that the network device performs input forwarding while storing the packet in a pause buffer block (not shown) of the input data path controller 216.

As discussed, the input forwarding controller 214 may perform several operations on an incoming packet, including parsing the packet header, performing an L2 lookup, performing an L3 lookup, processing an ingress access control list (ACL), classifying ingress traffic, and aggregating forwarding results. Although describing the tasks performed by the input forwarding controller 214 in this sequence, one of ordinary skill will understand that, for any process discussed herein, there can be additional, fewer, or alternative steps performed in similar or alternative orders, or in parallel, within the scope of the various embodiments unless otherwise stated.

In some embodiments, when a unicast packet enters through a front-panel port (e.g., a port of ingress MAC 212), the input forwarding controller 214 may first perform packet header parsing. For example, the input forwarding controller 214 may parse the first 128 bytes of the packet to extract and save information such as the L2 header, EtherType, L3 header, and TCP IP protocols.

As the packet goes through the ingress forwarding pipeline 210, the packet may be subject to L2 switching and L3 routing lookups. The input forwarding controller 214 may first examine the destination MAC address of the packet to determine whether to switch the packet (i.e., L2 lookup) or route the packet (i.e., L3 lookup). For example, if the destination MAC address matches the network device's own MAC address, the input forwarding controller 214 can perform an L3 routing lookup. If the destination MAC address does not match the network device's MAC address, the input forwarding controller 214 may perform an L2 switching lookup based on the destination MAC address to determine a virtual LAN (VLAN) identifier. If the input forwarding controller 214 finds a match in the MAC address table, the input forwarding controller 214 can send the packet to the egress port. If there is no match for the destination MAC address and VLAN identifier, the input forwarding controller 214 can forward the packet to all ports in the same VLAN.

During L3 routing lookup, the input forwarding controller 214 can use the destination IP address for searches in an L3 host table. This table can store forwarding entries for directly attached hosts and learned/32 host routes. If the destination IP address matches an entry in the host table, the entry will provide the destination port, next-hop MAC address, and egress VLAN. If the input forwarding controller 214 finds no match for the destination IP address in the host table, the input forwarding controller 214 can perform a longest-prefix match (LPM) lookup in an LPM routing table.

In addition to forwarding lookup, the input forwarding controller 214 may also perform ingress ACL processing on the packet. For example, the input forwarding controller 214 may check ACL ternary content-addressable memory (TCAM) for ingress ACL matches. In some embodiments, each ASIC may have an ingress ACL TCAM table of 4000 entries per slice to support system internal ACLs and user-defined ingress ACLs. These ACLs can include port ACLs, routed ACLs, and VLAN ACLs, among others. In some embodiments, the input forwarding controller 214 may localize the ACL entries per slice and program them only where needed.

In some embodiments, the input forwarding controller 214 may also support ingress traffic classification. For example, from an ingress interface, the input forwarding controller 214 may classify traffic based on the address field, IEEE 802.1q class of service (CoS), and IP precedence or differentiated services code point in the packet header. In some embodiments, the input forwarding controller 214 can assign traffic to one of eight quality-of-service (QoS) groups. The QoS groups may internally identify the traffic classes used for subsequent QoS processes as packets traverse the system.

In some embodiments, the input forwarding controller 214 may collect the forwarding metadata generated earlier in the pipeline (e.g., during packet header parsing, L2 lookup, L3 lookup, ingress ACL processing, ingress traffic classification, forwarding results generation, etc.) and pass it downstream through the input data path controller 216. For example, the input forwarding controller 214 can store a 64-byte internal header along with the packet in the packet buffer. This internal header can include 16 bytes of iETH (internal communication protocol) header information, which the input forwarding controller 214 can prepend to the packet when transferring the packet to the output data path controller 222 through the broadcast network 230. The network device can strip the 16-byte iETH header when the packet exits the front-panel port of the egress MAC 226. The network device may use the remaining internal header space (e.g., 48 bytes) to pass metadata from the input forwarding queue to the output forwarding queue for consumption by the output forwarding engine.

In some embodiments, the input data path controller 216 can perform ingress accounting functions, admission functions, and flow control for a no-drop class of service. The ingress admission control mechanism can determine whether to admit the packet into memory based on the amount of buffer memory available and the amount of buffer space already used by the ingress port and traffic class. The input data path controller 216 can forward the packet to the output data path controller 222 through the broadcast network 230.

As discussed, in some embodiments, the broadcast network 230 can comprise a set of point-to-multipoint wires that provide connectivity between all slices of the ASIC. The input data path controller 216 may have a point-to-multipoint connection to the output data path controller 222 on all slices of the network device, including its own slice.

In some embodiments, the output data path controller 222 can perform egress buffer accounting, packet queuing, scheduling, and multicast replication. In some embodiments, all ports can dynamically share the egress buffer resource. In some embodiments, the output data path controller 222 can also perform packet shaping. In some embodiments, the network device can implement a simple egress queuing architecture. For example, in the event of egress port congestion, the output data path controller 222 can directly queue packets in the buffer of the egress slice. In some embodiments, there may be no virtual output queues (VoQs) on the ingress slice. This approach can simplify system buffer management and queuing.

As discussed, in some embodiments, one or more network devices can support up to 10 traffic classes on egress, 8 user-defined classes identified by QoS group identifiers, a CPU control traffic class, and a switched port analyzer (SPAN) traffic class. Each user-defined class can have a unicast queue and a multicast queue per egress port. This approach can help ensure that no single port will consume more than its fair share of the buffer memory and cause buffer starvation for other ports.

In some embodiments, multicast packets may go through similar ingress and egress forwarding pipelines as the unicast packets but instead use multicast tables for multicast forwarding. In addition, multicast packets may go through a multistage replication process for forwarding to multiple destination ports. In some embodiments, the ASIC can include multiple slices interconnected by a non-blocking internal broadcast network. When a multicast packet arrives at a front-panel port, the ASIC can perform a forwarding lookup. This lookup can resolve local receiving ports on the same slice as the ingress port and provide a list of intended receiving slices that have receiving ports in the destination multicast group. The forwarding engine may replicate the packet on the local ports, and send one copy of the packet to the internal broadcast network, with the bit vector in the internal header set to indicate the intended receiving slices. In this manner, only the intended receiving slices may accept the packet off of the wire of the broadcast network. The slices without receiving ports for this group can discard the packet. The receiving slice can then perform local L3 replication or L2 fan-out lookup and replication to forward a copy of the packet to each of its local receiving ports.

In FIG. 2, the forwarding pipeline 200 also includes a flow cache 240, which when combined with direct export of collected telemetry from the ASIC (i.e., data hardware streaming), can enable collection of packet and flow metadata at line rate while avoiding CPU bottleneck or overhead. The flow cache 240 can provide a full view of packets and flows sent and received by the network device. The flow cache 240 can collect information on a per-packet basis, without sampling and without increasing latency or degrading performance of the network device. To accomplish this, the flow cache 240 can pull information from the forwarding pipeline 200 without being in the traffic path (i.e., the ingress forwarding pipeline 210 and the egress forwarding pipeline 220).

In addition to the traditional forwarding information, the flow cache 240 can also collect other metadata such as detailed IP and TCP flags and tunnel endpoint identifiers. In some embodiments, the flow cache 240 can also detect anomalies in the packet flow such as inconsistent TCP flags. The flow cache 240 may also track flow performance information such as the burst and latency of a flow. By providing this level of information, the flow cache 240 can produce a better view of the health of a flow. Moreover, because the flow cache 240 does not perform sampling, the flow cache 240 can provide complete visibility into the flow.

In some embodiments, the flow cache 240 can include an events mechanism to complement anomaly detection. This configurable mechanism can define a set of parameters that represent a packet of interest. When a packet matches these parameters, the events mechanism can trigger an event on the metadata that triggered the event (and not just the accumulated flow information). This capability can give the flow cache 240 insight into the accumulated flow information as well as visibility into particular events of interest. In this manner, networks, such as a network implementing the application and network analytics platform 100, can capture telemetry more comprehensively and not impact application and network performance.

Returning to FIG. 1, the network telemetry captured by the software sensors 112 and hardware sensors 114 can include metadata relating to individual packets (e.g., packet size, source address, source port, destination address, destination port, etc.); flows (e.g., number of packets and aggregate size of packets having the same source address/port, destination address/port, L3 protocol type, class of service, router/switch interface, etc. sent/received without inactivity for a certain time (e.g., 15 seconds) or sent/received over a certain duration (e.g., 30 minutes)); flowlets (e.g., flows of sub-requests and sub-responses generated as part of an original request or response flow and sub-flows of these flows); bidirectional flows (e.g., flow data for a request/response pair of flows having corresponding source address/port, destination address/port, etc.); groups of flows (e.g., flow data for flows associated with a certain process or application, server, user, etc.), sessions (e.g., flow data for a TCP session); or other types of network communications of specified granularity. That is, the network telemetry can generally include any information describing communication on all layers of the Open Systems Interconnection (OSI) model. In some embodiments, the network telemetry collected by the sensors 112 and 114 can also include other network traffic data such as hop latency, packet drop count, port utilization, buffer information (e.g., instantaneous queue length, average queue length, congestion status, etc.), and other network statistics.

The application and network analytics platform 100 can associate a flow with a server sending or receiving the flow, an application or process triggering the flow, the owner of the application or process, and one or more policies applicable to the flow, among other telemetry. The telemetry captured by the software sensors 112 can thus include server data, process data, user data, policy data, and other data (e.g., virtualization information, tenant information, sensor information, etc.). The server telemetry can include the server name, network address, CPU usage, network usage, disk space, ports, logged users, scheduled jobs, open files, and similar information. In some embodiments, the server telemetry can also include information about the file system of the server, such as the lists of files (e.g., log files, configuration files, device special files, etc.) and/or directories stored within the file system as well as the metadata for the files and directories (e.g., presence, absence, or modifications of a file and/or directory). In some embodiments, the server telemetry can further include physical or virtual configuration information (e.g., processor type, amount of random access memory (RAM), amount of disk or storage, type of storage, system type (e.g., 32-bit or 64-bit), operating system, public cloud provider, virtualization platform, etc.).

The process telemetry can include the process name (e.g., bash, httpd, netstat, etc.), process identifier, parent process identifier, path to the process (e.g., /usr2/username/bin/, /usr/local/bin, /usr/bin, etc.), CPU utilization, memory utilization, memory address, scheduling information, nice value, flags, priority, status, start time, terminal type, CPU time taken by the process, and the command string that initiated the process (e.g., “/opt/tetration/collectorket-collector --config_file/etc/tetration/collector/collector.config --timest amp_flow_info --logtostderr --utc_time_in_file_name true --max_num_ssl_sw_sensors 63000 --enable_client_certificate true”). The user telemetry can include information regarding a process owner, such as the user name, user identifier, user's real name, e-mail address, user's groups, terminal information, login time, expiration date of login, idle time, and information regarding files and/or directories of the user.

The customer/third party data sources 116 can include out-of-band data such as power level, temperature, and physical location (e.g., room, row, rack, cage door position, etc.). The customer/third party data sources 116 can also include third party data regarding a server such as whether the server is on an IP watch list or security report (e.g., provided by Cisco®, Arbor Networks® of Burlington, Mass., Symantec® Corp. of Sunnyvale, Calif., Sophos® Group plc of Abingdon, England, Microsoft® Corp. of Seattle, Wash., Verizon® Communications, Inc. of New York, N.Y., among others), geolocation data, and Whois data, and other data from external sources.

In some embodiments, the customer/third party data sources 116 can include data from a configuration management database (CMDB) or configuration management system (CMS) as a service. The CMDB/CMS may transmit configuration data in a suitable format (e.g., JavaScript® object notation (JSON), extensible mark-up language (XML), yet another mark-up language (YAML), etc.).

The processing pipeline 122 of the analytics engine 120 can collect and process the telemetry. In some embodiments, the processing pipeline 122 can retrieve telemetry from the software sensors 112 and the hardware sensors 114 every 100 ms or faster. Thus, the application and network analytics platform 100 may not miss or is much less likely than conventional systems to miss “mouse” flows, which typically collect telemetry every 60 seconds. In addition, as the telemetry tables flush so often, the software sensors 112 and the hardware sensors 114 do not or are much less likely than conventional systems to drop telemetry because of overflow/lack of memory. An additional advantage of this approach is that the application and network analytics platform is responsible for flow-state tracking instead of network devices. Thus, the ASICs of the network devices of various embodiments can be simpler or can incorporate other features.

In some embodiments, the processing pipeline 122 can filter out extraneous or duplicative data or it can create summaries of the telemetry. In some embodiments, the processing pipeline 122 may process (and/or the software sensors 112 and hardware sensors 114 may capture) only certain types of telemetry and disregard the rest. For example, the processing pipeline 122 may process (and/or the sensors may monitor) only high-priority telemetry, telemetry associated with a particular subnet (e.g., finance department, human resources department, etc.), telemetry associated with a particular application (e.g., business-critical applications, compliance software, health care applications, etc.), telemetry from external-facing servers, etc. As another example, the processing pipeline 122 may process (and/or the sensors may capture) only a representative sample of telemetry (e.g., every 1,000th packet or other suitable sample rate).

Collecting and/or processing telemetry from multiple servers of the network (including within multiple partitions of virtualized hosts) and from multiple network devices operating between the servers can provide a comprehensive view of network behavior. The capture and/or processing of telemetry from multiple perspectives rather than just at a single device located in the data path (or in communication with a component in the data path) can allow the data to be correlated from the various data sources, which may be used as additional data points by the analytics engine 120.

In addition, collecting and/or processing telemetry from multiple points of view can enable capture of more accurate data. For example, a conventional network may consist of external-facing network devices (e.g., routers, switches, network appliances, etc.) such that the conventional network may not be capable of monitoring east-west telemetry, including VM-to-VM or container-to-container communications on a same host. As another example, the conventional network may drop some packets before those packets traverse a network device incorporating a sensor. The processing pipeline 122 can substantially mitigate or eliminate these issues altogether by capturing and processing telemetry from multiple points of potential failure. Moreover, the processing pipeline 122 can verify multiple instances of data for a flow (e.g., telemetry from a source (i.e., physical server, hypervisory, container orchestrator, other virtual entity manager, VM, container, and/or other virtual entity, one or more network devices; and a destination) against one another.

In some embodiments, the processing pipeline 122 can assess a degree of accuracy of telemetry for a single flow captured by multiple sensors and utilize the telemetry from a single sensor determined to be the most accurate and/or complete. The degree of accuracy can be based on factors such as network topology (e.g., a sensor closer to the source may be more likely to be more accurate than a sensor closer to the destination), a state of a sensor or a server hosting the sensor (e.g., a compromised sensor/server may have less accurate telemetry than an uncompromised sensor/server), or telemetry volume (e.g., a sensor capturing a greater amount of telemetry may be more accurate than a sensor capturing a smaller amount of telemetry).

In some embodiments, the processing pipeline 122 can assemble the most accurate telemetry from multiple sensors. For instance, a first sensor along a data path may capture data for a first packet of a flow but may be missing data for a second packet of the flow while the reverse situation may occur for a second sensor along the data path. The processing pipeline 122 can assemble data for the flow from the first packet captured by the first sensor and the second packet captured by the second sensor.

In some embodiments, the processing pipeline 122 can also disassemble or decompose a flow into sequences of request and response flowlets (e.g., sequences of requests and responses of a larger request or response) of various granularities. For example, a response to a request to an enterprise application may result in multiple sub-requests and sub-responses to various back-end services (e.g., authentication, static content, data, search, sync, etc.). The processing pipeline 122 can break a flow down to its constituent components to provide greater insight into application and network performance. The processing pipeline 122 can perform this resolution in real time or substantially real time (e.g., no more than a few minutes after detecting the flow).

The processing pipeline 122 can store the telemetry in a data lake (not shown), a large-scale storage repository characterized by massive storage for various types of data, enormous processing power, and the ability to handle nearly limitless concurrent tasks or jobs. In some embodiments, the analytics engine 120 may deploy at least a portion of the data lake using the Hadoop® Distributed File System (HDFS™) from Apache® Software Foundation of Forest Hill, Md. HDFS™ is a highly scalable and distributed file system that can scale to thousands of cluster nodes, millions of files, and petabytes of data. A feature of HDFS™ is its optimization for batch processing, such as by coordinating data computation to where data is located. Another feature of HDFS™ is its utilization of a single namespace for an entire cluster to allow for data coherency in a write-once, read-many access model. A typical HDFS™ implementation separates files into blocks, which are typically 64 MB in size and replicated in multiple data nodes. Clients access data directly from the data nodes.

The processing pipeline 122 can propagate the processed data to one or more engines, monitors, and other components of the analytics engine 120 (and/or the components can retrieve the data from the data lake), such as an application dependency mapping (ADM) engine 124, a policy engine 126, an inventory monitor 128, a flow monitor 130, and an enforcement engine 132.

The ADM engine 124 can determine dependencies of applications running in the network, i.e., how processes on different servers interact with one another to perform the functions of the application. Particular patterns of traffic may correlate with particular applications. The ADM engine 124 can evaluate flow data, associated data, and customer/third party data processed by the processing pipeline 122 to determine the interconnectivity or dependencies of the application to generate a graph for the application (i.e., an application dependency mapping). For example, in a conventional three-tier architecture for a web application, first servers of the web tier, second servers of the application tier, and third servers of the data tier make up the web application. From flow data, the ADM engine 124 may determine that there is first traffic flowing between external servers on port 80 of the first servers corresponding to Hypertext Transfer Protocol (HTTP) requests and responses. The flow data may also indicate second traffic between first ports of the first servers and second ports of the second servers corresponding to application server requests and responses and third traffic flowing between third ports of the second servers and fourth ports of the third servers corresponding to database requests and responses. The ADM engine 124 may define an application dependency map or graph for this application as a three-tier application including a first endpoint group (EPG) (i.e., groupings of application tiers or clusters, applications, and/or application components for implementing forwarding and policy logic) comprising the first servers, a second EPG comprising the second servers, and a third EPG comprising the third servers.

The policy engine 126 can automate (or substantially automate) generation of policies for the network and simulate the effects on telemetry when adding a new policy or removing an existing policy. Policies establish whether or not to allow (i.e., forward) or deny (i.e., drop) a packet or flow in a network. Policies can also designate a specific route by which the packet or flow traverses the network. In addition, policies can classify the packet or flow so that certain kinds of traffic receive differentiated service when used in combination with queuing techniques such as those based on priority, fairness, weighted fairness, token bucket, random early detection, round robin, among others, or to enable the application and network analytics platform 100 to perform certain operations on the servers and/or flows (e.g., enable features like ADM, application performance management (APM) on labeled servers, prune inactive sensors, or to facilitate search on applications with external traffic, etc.).

The policy engine 126 can automate or at least significantly reduce manual processes for generating policies for the network. In some embodiments, the policy engine 126 can define policies based on user intent. For instance, an enterprise may have a high-level policy that production servers cannot communicate with development servers. The policy engine 126 can convert the high-level business policy to more concrete enforceable policies. In this example, the user intent is to prohibit production machines from communicating with development machines. The policy engine 126 can translate the high-level business requirement to a more concrete representation in the form of a network policy, such as a policy that disallows communication between a subnet associated with production (e.g., 10.1.0.0/16) and a subnet associated with development (e.g., 10.2.0.0/16).

In some embodiments, the policy engine 126 may also be capable of generating system-level policies not traditionally supported by network policies. For example, the policy engine 126 may generate one or more policies limiting write access of a collector process to /local/collector/, and thus the collector may not write to any directory of a server except for this directory.

In some embodiments, the policy engine 126 can receive an application dependency map (whether automatically generated by the ADM engine 124, manually defined and transmitted by a CMDB/CMS or a component of the presentation layer 140 (e.g., Web GUI 142, REST API 144, etc.)) and define policies that are consistent with the received application dependency map. In some embodiments, the policy engine 126 can generate whitelist policies in accordance with the received application dependency map. In a whitelist system, a network denies a packet or flow by default unless a policy exists that allows the packet or flow. A blacklist system, on the other hand, permits a packet or flow as a matter of course unless there is a policy that explicitly prohibits the packet or flow. In other embodiments, the policy engine 126 can generate blacklist policies, such as to maintain consistency with existing policies.

In some embodiments, the policy engine 126 can validate whether changes to policy will result in network misconfiguration and/or vulnerability to attacks. The policy engine 126 can provide what if analysis, i.e., analysis regarding what would happen to network traffic upon adding one or more new policies, removing one or more existing policies, or changing membership of one or more EPGs (e.g., adding one or more new endpoints to an EPG, removing one or more endpoints from an EPG, or moving one or more endpoints from one EPG to another). In some embodiments, the policy engine 126 can utilize historical ground truth flows for simulating network traffic based on what if experiments. That is, the policy engine 126 may apply the addition or removal of policies and/or changes to EPGs to a simulated network environment that mirrors the actual network to evaluate the effects of the addition or removal of policies and/or EPG changes. The policy engine 126 can determine whether the policy changes break or misconfigure networking operations of any applications in the simulated network environment or allow any attacks to the simulated network environment that were previously thwarted by the actual network with the original set of policies. The policy engine 126 can also determine whether the policy changes correct misconfigurations and prevent attacks that occurred in the actual network. In some embodiments, the policy engine 126 can also evaluate real time flows in a simulated network environment configured to operate with an experimental policy set or experimental set of EPGs to understand how changes to policy or EPGs affect network traffic in the actual network.

The inventory monitor 128 can continuously track the network's assets (e.g., servers, network devices, applications, etc.) based on telemetry processed by the processing pipeline 122. In some embodiments, the inventory monitor 128 can assess the state of the network at a specified interval (e.g., every 1 minute). In some embodiments, the inventory monitor 128 can periodically take snapshots of the states of applications, servers, network devices, and/or other elements of the network. In other embodiments, the inventory monitor 128 can capture the snapshots when events of interest occur, such as an application experiencing latency that exceeds an application latency threshold; the network experiencing latency that exceeds a network latency threshold; failure of a server, network device, or other network element; and similar circumstances. Snapshots can include a variety of telemetry associated with network elements. For example, a snapshot of a server can information regarding processes executing on the server at a time of capture, the amount of CPU utilized by each process (e.g., as an amount of time and/or a relative percentage), the amount of virtual memory utilized by each process (e.g., in bytes or as a relative percentage), the amount of disk utilized by each process (e.g., in bytes or as a relative percentage), and a distance (physical or logical, relative or absolute) from one or more other network elements.

In some embodiments, on a change to the network (e.g., a server updating its operating system or running a new process; a server communicating on a new port; a VM, container, or other virtualized entity migrating to a different host and/or subnet, VLAN, VxLAN, or other network segment; etc.), the inventory monitor 128 can alert the enforcement engine 132 to ensure that the network's policies are still in force in view of the change(s) to the network.

The flow monitor 130 can analyze flows to detect whether they are associated with anomalous or malicious traffic. In some embodiments, the flow monitor 130 may receive examples of past flows determined to be compliant traffic and/or past flows determined to be non-compliant or malicious traffic. The flow monitor 130 can utilize machine learning to analyze telemetry processed by the processing pipeline 122 and classify each current flow based on similarity to past flows. On detection of an anomalous flow, such as a flow that does not match any past compliant flow within a specified degree of confidence or a flow previously classified as non-compliant or malicious, the policy engine 126 may send an alert the enforcement engine 132 and/or to the presentation layer 140. In some embodiments, the network may operate within a trusted environment for a period of time so that the analytics engine 120 can establish a baseline of normal operation

The enforcement engine 132 can be responsible for enforcing policy. For example, the enforcement engine 132 may receive an alert from the inventory monitor 128 on a change to the network or an alert from the flow monitor upon the flow monitor 130 detecting an anomalous or malicious flow. The enforcement engine 132 can evaluate the network to distribute new policies or changes to existing policies, enforce new and existing policies, and determine whether to generate new policies and/or revise/remove existing policies in view of new assets or to resolve anomalous.

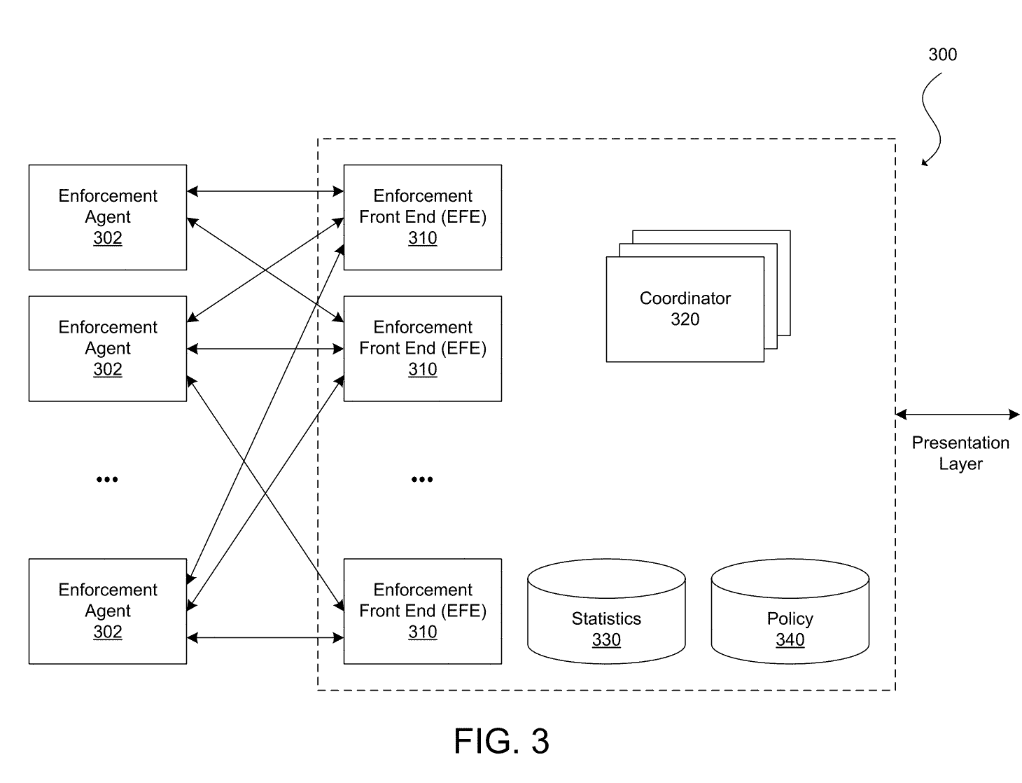

FIG. 3 illustrates an example of an enforcement engine 300 that represents one of many possible implementations of the enforcement engine 132. The enforcement engine 300 can include one or more enforcement front end processes (EFEs) 310, a coordinator cluster 320, a statistics store 330, and a policy store 340. While the enforcement engine 300 includes specific components in this example, one of ordinary skill in the art will understand that the configuration of the enforcement engine 300 is one possible configuration and that other configurations with more or less components are also possible.

FIG. 3 shows the EFEs 310 in communication with enforcement agents 302. The enforcement agents 302 represent one of many possible implementations of the software sensors 112 and/or the hardware sensors 114 of FIG. 1. That is, in some embodiments, the software sensors 112 and/or the hardware sensors 114 may capture telemetry as well as operate as enforcement agents of the enforcement engine 132. In some embodiments, only the software sensors 112 may operate as the enforcement agents 302 and the hardware sensors 114 only capture network telemetry. In this manner, hardware engineers may design smaller, more efficient, and more cost-effective ASICs for network devices.

After installation on a server and/or network device of the network, each enforcement agent 302 can register with the coordinator cluster 320 via communication with one or more of the EFEs 310. Upon successful registration, each enforcement agent 302 may receive policies applicable to the host (i.e., physical or virtual server, network device, etc.) on which the enforcement agent 302 operates. In some embodiments, the enforcement engine 300 may encode the policies in a high-level, platform-independent format. In some embodiments, each enforcement agent 302 can determine its host's operating environment, convert the high-level policies into platform-specific policies, apply certain platform-specific optimizations based on the operating environment, and proceed to enforce the policies on its host. In other embodiments, the enforcement engine 300 may translate the high-level policies to the platform-specific format remotely from the enforcement agents 302 before distribution.

As discussed, the enforcement agents 302 can also function as the software sensors 112 in some embodiments. In addition to capturing telemetry from a server in these embodiments, each enforcement agent 302 may also collect data related to policy enforcement. For example, the enforcement engine 300 can determine the policies that are applicable for the host of each enforcement agent 302 and distribute the applicable policies to each enforcement agent 302 via the EFEs 310. Each enforcement agent 302 can monitor flows sent/received by its host and track whether each flow complied with the applicable policies. Thus, each enforcement agent 302 can keep counts of the number of applicable policies for its host, the number of compliant flows with respect to each policy, and the number of non-compliant flows with respect to each policy, etc.

In some embodiments, the EFEs 310 can be responsible for storing platform-independent policies in memory, handling registration of the enforcement agents 302, scanning the policy store 340 for updates to the network's policies, distribute updated policies to the enforcement agents 302, and collect telemetry (including policy enforcement data) transmitted by the enforcement agents 302. In the example of FIG. 3, the EFEs 310 can function as intermediaries between the enforcement agents 302 and the coordinator cluster 320. This can add a layer of security between servers and the enforcement engine 300. For example, the enforcement agents 302 can operate under the least-privileged principle having trust in only the policy store 340 and no trust in the EFEs 310. The enforcement agents 302 and the EFEs 310 must sign and authenticate all transactions between them, including configuration, registration, and updates to policy.

The coordinator cluster 320 operates as the controller for the enforcement engine 300. In the example of FIG. 3, the coordinator cluster 320 implements a high availability scheme (e.g., ZooKeeper, doozerd, and etcd) in which the cluster elects one coordinator instance master and the remaining coordinator instances serve as standby instances. The coordinator cluster 320 can manage the assignment of the enforcement agents 302 to the EFEs 310. In some embodiments, each enforcement agent 302 may initially register with the EFE 310 closest (physically or logically) to the agent's server but the coordinator cluster 320 may reassign the enforcement agent to a different EFE, such as for load balancing and/or in the event of the failure of one or more of the EFEs 310. In some embodiments, the coordinator cluster 320 may use sharding for load balancing and providing high availability for the EFEs 310.

The statistics store 330 can maintain statistics relating to policy enforcement, including mappings of user intent statements to platform-dependent policies and the number of times the enforcement agents 302 successfully applied or unsuccessfully applied the policies. In some embodiments, the enforcement engine 300 may implement the statistics store 330 using Druid® or other relational database platform. The policy store 340 can include collections of data related to policy enforcement, such as registration data for the enforcement agents 302 and the EFEs 310, user intent statements, and platform-independent policies. In some embodiments, the enforcement engine 300 may implement the policy store 340 using software provided by MongoDB®, Inc. of New York, N.Y. or other NoSQL database.

In some embodiments, the coordinator cluster 320 can expose application programming interface (API) endpoints (e.g., such as those based on the simple object access protocol (SOAP), a service oriented architecture (SOA), a representational state transfer (REST) architecture, a resource oriented architecture (ROA), etc.) for capturing user intent and to allow clients to query the enforcement status of the network.

In some embodiments, the coordinator cluster 320 may also be responsible for translating user intent to concrete platform-independent policies, load balancing the EFEs 310, and ensuring high availability of the EFEs 310 to the enforcement agents 302. In other embodiments, the enforcement engine 300 can integrate the functionality of an EFE and a coordinator or further divide the functionality of the EFE and the coordinator into additional components.

The enforcement engine 300 can receive various inputs for facilitating enforcement of policy in the network via the presentation layer 140. In some embodiments, the enforcement engine 300 can receive one or more criteria or filters for identifying network entities (e.g., subnets, servers, network devices, applications, flows, and other network elements of various granularities) and one or more actions to perform on the identified entities. The criteria or filters can include IP addresses or ranges, MAC addresses, server names, server domain name system (DNS) names, geographic locations, departments, functions, VPN routing/forwarding (VRF) tables, among other filters/criteria. The actions can include those similar to access control lists (ACLs) (e.g., permit, deny, redirect, etc.); labeling actions (i.e., classifying groups of servers, servers, applications, flows, and/or other network elements of varying granularities for search, differentiated service, etc.); and control actions (e.g., enabling/disabling particular features, pruning inactive sensors/agents, enabling flow search on applications with external traffic, etc.); among others.

In some embodiments, the enforcement engine 300 can receive user intent statements (i.e., high-level expressions relating to how network entities may operate in a network) and translate them to concrete policies that the enforcement agents 302 can apply to their hosts. For example, the coordinator cluster 320 can receive a user intent statement and translate the statement into one or more policies, distribute them to the enforcement agents 302 via the EFEs 310, and direct enforcement by the enforcement agents 302. The enforcement engine 300 can also track changes to user intent statements and update the policy store 340 in view of the changes and issue warnings when inconsistencies arise among the policies.

Returning to FIG. 1, the presentation layer 140 can include a web graphical user interface (GUI) 142, API endpoints 144, and an event-based notification system 146. In some embodiments, the enforcement engine 300 may implement the web GUI 142 using Ruby on Rails™ as the web application framework. Ruby on Rails™ is model-view-controller (MVC) framework that provides default structures for a database, a web service, and web pages. Ruby on Rails™ relies on web standards such as JSON or XML for data transfer, and hypertext markup language (HTML), cascading style sheets, (CSS), and JavaScript® for display and user interfacing.

In some embodiments, the enforcement engine 300 may implement the API endpoints 144 using Hadoop® Hive from Apache® for the back end, and Java® Database Connectivity (JDBC) from Oracle® Corporation of Redwood Shores, Calif., as an API layer. Hive is a data warehouse infrastructure that provides data summarization and ad hoc querying. Hive provides a mechanism to query data using a variation of structured query language (SQL) called HiveQL. JDBC is an application programming interface (API) for the programming language Java®, which defines how a client may access a database.

In some embodiments, the enforcement engine 300 may implement the event-based notification system using Hadoop® Kafka. Kafka is a distributed messaging system that supports partitioning and replication. Kafka uses the concept of topics. Topics are feeds of messages in specific categories. In some embodiments, Kafka can take raw packet captures and telemetry information as input, and output messages to a security information and event management (SIEM) platform that provides users with the capability to search, monitor, and analyze machine-generated data.

In some embodiments, each server in the network may include a software sensor and each network device may include a hardware sensor 114. In other embodiments, the software sensors 112 and hardware sensors 114 can reside on a portion of the servers and network devices of the network. In some embodiments, the software sensors 112 and/or hardware sensors 114 may operate in a full-visibility mode in which the sensors collect telemetry from every packet and every flow or a limited-visibility mode in which the sensors provide only the conversation view required for application insight and policy generation.

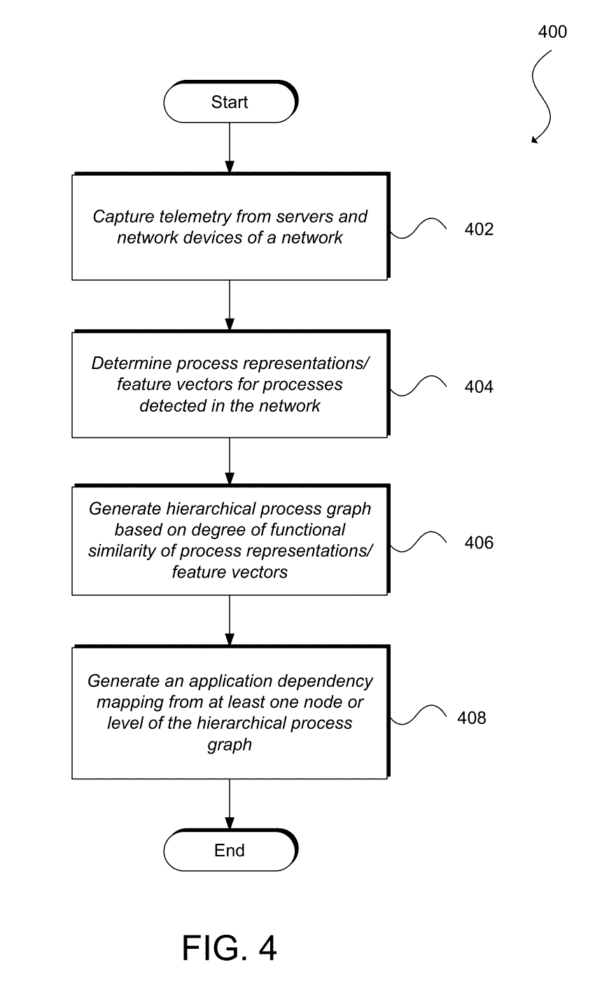

FIG. 4 illustrates an example of a method 400 for automating application dependency map (ADM) for a data center to facilitate process-level network segmentation. For example, an analytics engine (e.g., the analytics engine 120 of FIG. 1) can receive the generated ADM to determine policies permitting communications between processes insofar as the generated ADM indicates a dependency or valid flow between the processes. One of ordinary skill will understood that, for any method discussed herein, there can be additional, fewer, or alternative steps performed in similar or alternative orders, or in parallel, within the scope of the various embodiments unless otherwise stated. A network, and particularly, an application and network analytics platform (e.g., the application and network analytics platform 100 of FIG. 1), an analytics engine (e.g., the analytics engine 120), an ADM engine (e.g., the ADM engine 124), a network operating system, a virtual entity manager, or similar system can perform the method 400.

In the example of FIG. 4, the method 400 may begin at step 402 in which sensors can (e.g., the software sensors 112 and/or hardware sensors 114 of FIG. 1) capture telemetry for servers and network devices of the network (e.g., flow data, host data, process data, user data, policy data, etc.). In some embodiments, the application and network analytics platform may also collect virtualization information, network topology information, and application information (e.g., configuration information, previously generated application dependency maps, application policies, etc.). In some embodiments, the application and network analytics platform may also collect out-of-band data (e.g., power level, temperature, and physical location) and customer/third party data (e.g., CMDB or CMS as a service, Whois, geocoordinates, etc.). As discussed, the software sensors 112 and hardware sensors 114 can collect the telemetry from multiple perspectives to provide a comprehensive view of network behavior. The software sensors 112 may include sensors along multiple points of a data path (e.g., network devices, physical or bare metals servers) and within multiple partitions of a physical host (e.g., hypervisor, container orchestrator, virtual entity manager, VM, container, other virtual entity, etc.).

After collection of the telemetry, the method 400 may continue on to step 404, in which the application and network analytics platform can determine process representations for detected processes. In some embodiments, determining the process representations can involve extracting process features from the command strings of each process running in the network or data center. Table 1 recites pseudo code for one possible implementation for extracting the process features.

TABLE 1
Pseudo code for extracting process features from
a command string in accordance with an embodiment

| | |
|---|---|
| 1: | initialize B[ ] // base name of a process |
| 2: | initialize P[ ] // the process's parameters |
| 3: | initialize V[ ] // the feature vector for the process/process representation |
| 4: | initialize F1[ ] // MIME Types of interest |
| 5: | initialize F2[ ][ ] // matrix/mapping of processes and parameters of interest |
| 6: | tokenize command string C |
| 7: | for each token Tᵢ in C: |

| | |
|---|---|
| 8: | identify the MIME Type of each token Tᵢ |
| 9: | if (MIME Type of Tᵢ is binary) |

| | |
|---|---|
| 10: | B[ ] += Ti |

| | |
|---|---|
| 11: | else |

| | |
|---|---|
| 12: | P[ ] += Ti |

| | |
|---|---|
| 13: | if (B[0] does not end with the name of a language interpreter or shell) |

| | |
|---|---|
| 14: | break |

| | |
|---|---|
| 15: | V[ ] = B[ ] |
| 16: | for each parameter Pᵢ in P[ ] |

| | |
|---|---|
| 17: | if (MIME Type of Pᵢ is memberOf F1[ ] or Pᵢ is memberOf F2[(B[0])][ ]) |

| | |
|---|---|
| 18: | V[ ] += P[i] |

Thus, in at least some embodiments, process feature extraction can include tokenizing a command string using a delimiter (e.g., whitespace). Process feature extraction can further include sequencing through the tokens to find the first executable file or script based on the Multipurpose Internet Mail Extensions (MIME) type of the token. In this example, the MIME type of the first executable file or script is a binary file. This token can represent the base name of the process (i.e., the full path to the executable file or script).

If the base name ends with the name of a language interpreter or a shell, then the process may includes sub-processes, and the sequencing of the tokens continues to identify additional executable files and scripts. A feature extractor of the application and network analytics platform can append these additional executable files and scripts to the base name. The feature extractor may treat the remaining tokens as the parameters or arguments of the process.

The feature extractor can analyze the MIME type of the parameters and retain only those parameters whose MIME Types are of interest (e.g., .jar). The feature extractor can also retain those parameters that are associated with a particular process and predetermined to be of interest, such as by filtering a parameter according to a mapping or matrix of processes and parameters of interest.

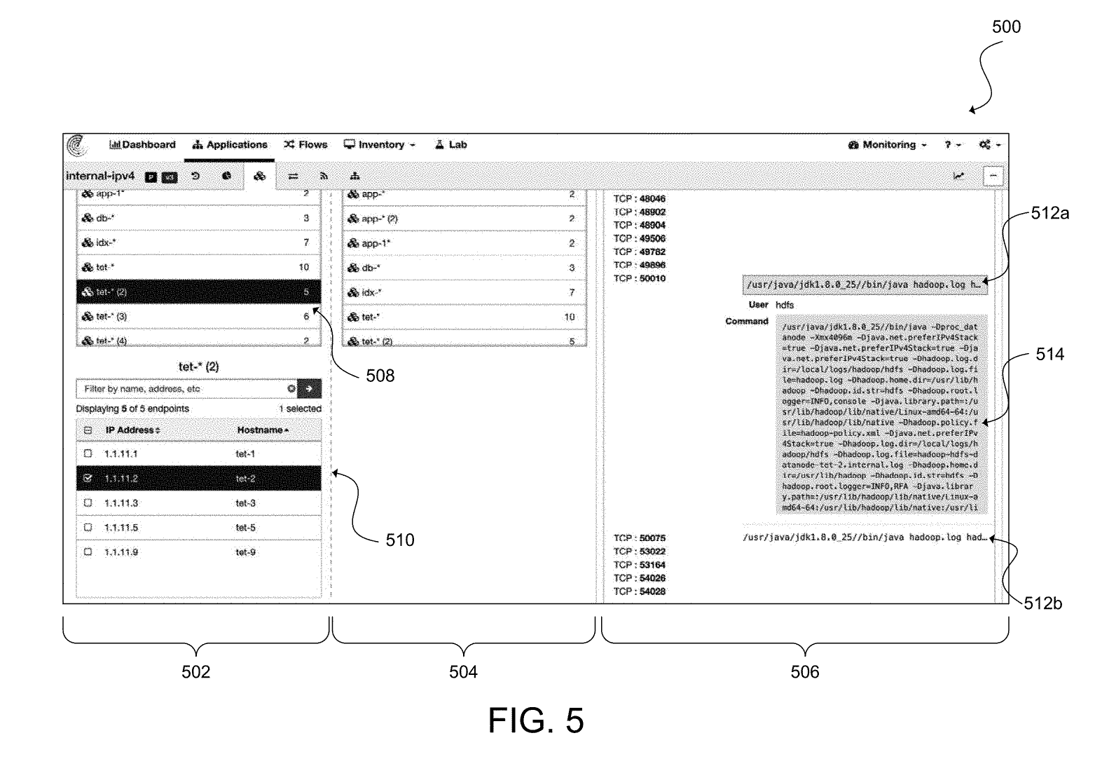

FIG. 5 illustrates an example of a graphical user interface (GUI) 500 for the application dependency mapping (ADM) engine (e.g., the ADM engine 124 of FIG. 1) of an application and network analytics platform (e.g., the application and network analytics platform 100). The ADM GUI 500 can include a source panel 502, a destination panel 504, and a server panel 506. The source panel 502 can display a list of source clusters (i.e., applications or application components) detected by the ADM engine. In the example of FIG. 5, a user has selected a source cluster or application/application component 508 which may subsequently bring up a list of servers of the selected cluster/application/application component below the list of source clusters/applications/application components. The example of FIG. 5 also indicates that the user has further selected a server 510 to populate the server panel 506 with information regarding the selected server 510.

The server panel 506 can display a list of the ports for the selected server 510 that can include a protocol, a port number, and a process representation (e.g., process representations 512a and 512b) for ports of the server having network activity. In the example of FIG. 5, the user has selected to view further details regarding process 512a, which can be associated with a user or owner (i.e., “hdfs”) and a full command string 514 to invoke the process. As seen in FIG. 5, the process representation includes a base name of the process (i.e., “/usr/java/jdk1.8_0_25/bin/java”) and one or more parameters for the process (i.e., “hadoop.log h . . . ”). The application and network analytics platform can utilize the process representation 512a to provide users with a quick summary of the processes running on the server 510 in the front end as illustrated in FIG. 5. The application and network analytics platform can also utilize the process representation 512a as a feature vector for clustering the cluster/application/application component 508 in the back end as discussed elsewhere herein.

In some embodiments, the feature extractor may further simplify the process representation/feature vector by filtering out common paths which point to entities in the file system (e.g., the feature extractor may only retain “jdk1.8.0_25//bin/java/” and ignore /usr/java/” for the base name of the process representation 512a). In some embodiments, the feature extractor may also perform frequency analysis on different parts of the feature vector to further filter out uninformative words or parts (e.g., the feature extractor may only retain “jdk1.8.0_25/java/” and ignore “/bin” for the base name of the process representation 512a). In addition, some embodiments of the feature extractor may filter out version names if different versions of a process perform substantially the same function (e.g., the feature extractor may only retain “java” and ignore “jdk1.8.0_25” for the base name of the process representation 512a).

After feature extraction, the method 400 may continue to step 406 in which the network can determine one or more graph representations of the processes running in the network, such as a host-process graph, a process graph, and a hierarchical process graph, among others. A host-process graph can be a graph in which each node represents a pairing of server (e.g., server name, IP address, MAC address, etc.) and process (e.g., the process representation determined at step 404). Each edge of the host-process graph can represent one or more flows between nodes. Each node of the host-process graph can thus represent multiple processes, but processes represented by the same node are collocated (e.g., same server) and are functionally equivalent (e.g., similar or same process representation/process feature vector).

A process graph can combine nodes having a similar or the same process representation/feature vector (i.e., aggregating across servers). As a result, nodes of the process graph may not be indicative of physical topology like in the host-process graph. However, the communications and dependencies between different types of processes revealed by the process graph can help to identify multi-process applications, such as those applications including multiple processes executing on the same server.

A hierarchical process graph is similar to a process graph in that nodes of the hierarchical graph represent similar processes. The difference between the process graph and the hierarchical process graph is the degree of similarity between processes. While the nodes of the process graph can require a relatively high threshold of similarity between process representations/feature vectors to form a process cluster/node, the nodes of the hierarchical process graph may have different degrees of similarity between process representations/feature vectors. In some embodiments, the hierarchical process graph can be in the form of a dendrogram, tree, or similar data structure with a root node representing the data center as a monolithic enterprise application and leaf nodes representing individual processes that perform specific functions.

In some embodiments, the application and network analytics platform can utilize divisive hierarchical clustering techniques for generating the hierarchical process graph. Divisive hierarchical clustering can involve splitting or decomposing nodes representing commonly used services (i.e., a process used by multiple applications). In graph theory terms, these are the nodes that sit in the center of the graph. They can be identified by various “centrality” measures, such as degree centrality (i.e., the number of edges incident on a node or the number of edges to and/or from the node), betweenness centrality (i.e., the number of times a node acts as a bridge along the shortest path between two nodes), closeness centrality (i.e., the average length of the shortest path between a node and all other nodes of the graph), among others (e.g., Eigenvector centrality, percolation centrality, cross-clique centrality, Freeman centrality, etc.). Table 2 sets forth pseudo code for one possible implementation for generating a hierarchical process graph using divisive hierarchical clustering.

TABLE 2
Pseudo code for generating hierarchical process
graph using divisive hierarchical clustering.

| | |
|---|---|
| 1: | Generate process graph G with coarse degree of similarity |
| 2: | Select one or more centrality metrics |
| 3: | Compute the centrality Cᵢ of each node and/or edge of G |
| 4: | Remove the nodes and/or edges with max Ci from G |
| 5: | Check the size and composition of remaining components of G and repeat steps 2-4 to |
| | further break down large components |

Each of the components of the algorithm, for each successive iteration, can represent an application at an increasing level of granularity. For example, the root node (i.e., at the top of the hierarchy) may represent the data center as a monolithic application and child nodes may represent applications from various perspectives (e.g., enterprise intranet to human resources suite to payroll tool, etc.).

In some embodiments, the application and network analytics platform may generate the hierarchical process graph utilizing agglomerative clustering techniques. Agglomerative clustering can take an opposite approach from divisive hierarchical clustering. For example, instead of beginning from the top of the hierarchy to the bottom, agglomerative clustering may involve traversing the hierarchy from the bottom to the top. In such an approach, the application and network analytics platform may begin with individual nodes (i.e., type of process identified by process feature vector) and gradually combine nodes or groups of nodes together to form larger clusters. Certain measures of the quality of the cluster determine the nodes to group together at each iteration. A common measure of such quality is graph modularity.

The method 400 can conclude at step 408 in which the application and network analytics platform may derive an application dependency map from a node or level of the hierarchical process graph.

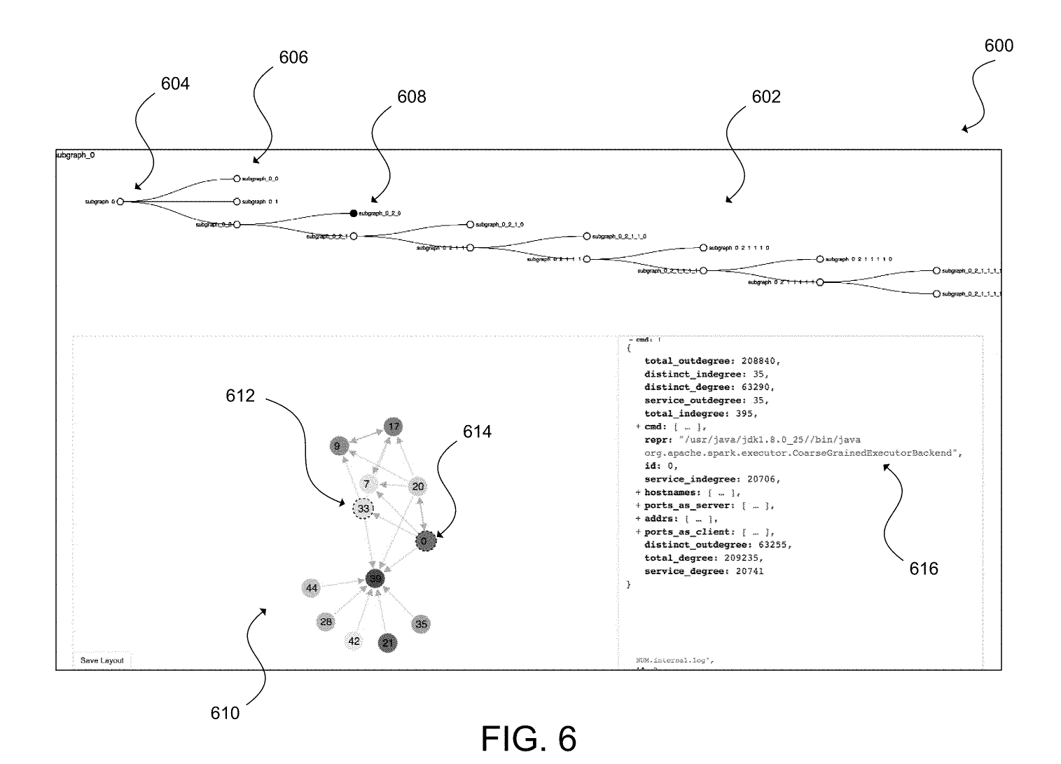

FIG. 6 illustrates an example of a graphical user interface 600 for an application dependency mapping (ADM) engine (e.g., the ADM engine 124 of FIG. 1) of a application and network analytics platform (e.g., the application and network analytics platform 100 of FIG. 1). The ADM GUI 600 can include a hierarchical graph representation 602 of processes detected in a network of the application and network analytics platform. The hierarchical graph representation 602 includes a root node 604 that can represent the data center application (i.e., processes grouped by a coarsest degree of functional similarity according to the process representation/feature vector of each process) and one more child nodes 606 that can represent other clusters or applications/application components detected by the ADM engine (i.e., processes grouped based on a finer degree of functional similarity according to their respective process representations/feature vectors). As discussed, the nodes of the hierarchical graph 602 can represent a collection of processes having functional similarity (i.e., applications) at various granularities and the edges can represent flows detected between the process clusters/applications/application components.

In the example of FIG. 6, a user has selected a child node 608 to view a graph representation of a process cluster or application 610. Each node of the graph 610 can represent a collection of processes having a specified degree of functional similarity (i.e., application components). Each edge of the graph 610 can represent flows detected between components of the application 610 (i.e., application dependencies). FIG. 6 also shows that the user has selected a pair of nodes or application components 612 and 614 to review details relating to their communication, including a process feature vector 616 indicating the process invoked to generate the flow(s).

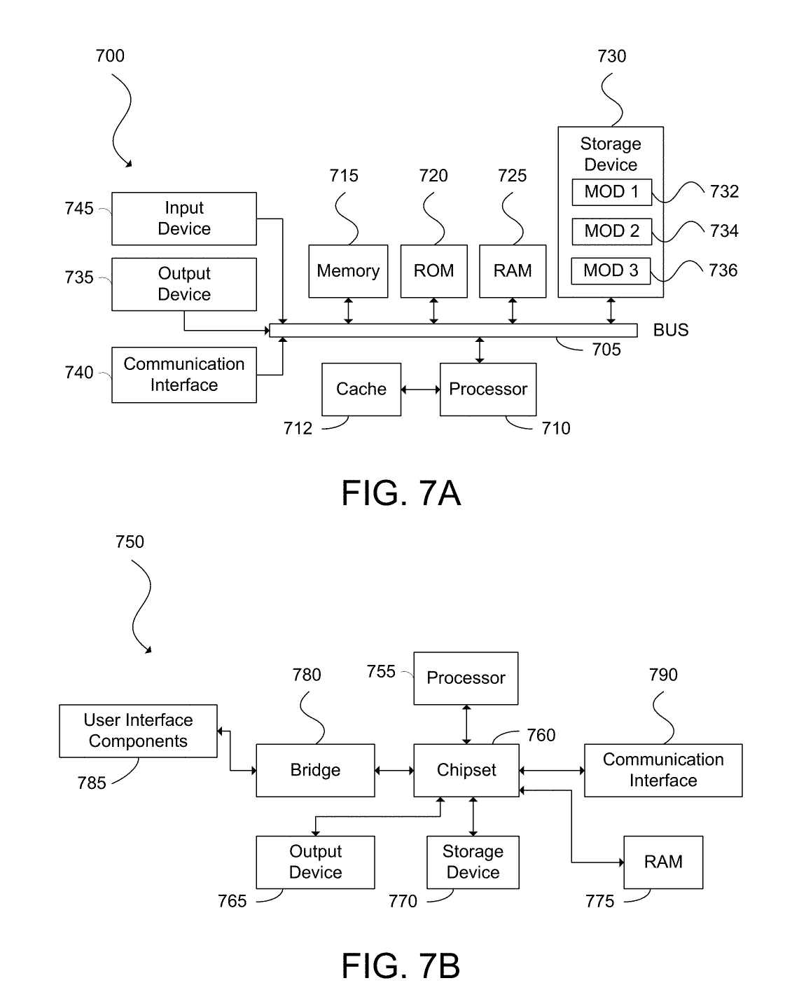

FIG. 7A and FIG. 7B illustrate systems in accordance with various embodiments. The more appropriate system will be apparent to those of ordinary skill in the art when practicing the various embodiments. Persons of ordinary skill in the art will also readily appreciate that other systems are possible.

FIG. 7A illustrates an example architecture for a conventional bus computing system 700 wherein the components of the system are in electrical communication with each other using a bus 705. The computing system 700 can include a processing unit (CPU or processor) 710 and a system bus 705 that may couple various system components including the system memory 715, such as read only memory (ROM) in a storage device 770 and random access memory (RAM) 775, to the processor 710. The computing system 700 can include a cache 712 of high-speed memory connected directly with, in close proximity to, or integrated as part of the processor 710. The computing system 700 can copy data from the memory 715 and/or the storage device 730 to the cache 712 for quick access by the processor 710. In this way, the cache 712 can provide a performance boost that avoids processor delays while waiting for data. These and other modules can control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing system 700, an input device 745 can represent any number of input mechanisms, such as a microphone for speech, a touch-protected screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing system 700. The communications interface 740 can govern and manage the user input and system output. There may be no restriction on operating on any particular hardware arrangement and therefore the basic features here may easily be substituted for improved hardware or firmware arrangements as they are developed.

Storage device 730 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, output device 735, and so forth, to carry out the function.

FIG. 7B illustrates an example architecture for a conventional chipset computing system 750 that can be used in accordance with an embodiment. The computing system 750 can include a processor 755, representative of any number of physically and/or logically distinct resources capable of executing software, firmware, and hardware configured to perform identified computations. The processor 755 can communicate with a chipset 760 that can control input to and output from the processor 755. In this example, the chipset 760 can output information to an output device 765, such as a display, and can read and write information to storage device 770, which can include magnetic media, and solid state media, for example. The chipset 760 can also read data from and write data to RAM 775. A bridge 780 for interfacing with a variety of user interface components 785 can be provided for interfacing with the chipset 760. The user interface components 785 can include a keyboard, a microphone, touch detection and processing circuitry, a pointing device, such as a mouse, and so on. Inputs to the computing system 750 can come from any of a variety of sources, machine generated and/or human generated.

The chipset 760 can also interface with one or more communication interfaces 790 that can have different physical interfaces. The communication interfaces 790 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 755 analyzing data stored in the storage device 770 or the RAM 775. Further, the computing system 700 can receive inputs from a user via the user interface components 785 and execute appropriate functions, such as browsing functions by interpreting these inputs using the processor 755.

It will be appreciated that computing systems 700 and 750 can have more than one processor 710 and 755, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
capturing telemetry from a plurality of servers and a plurality of network devices of a network;
determining one or more feature vectors for a plurality of processes executing in the network based on the telemetry;
determining a plurality of nodes for a graph based on measures of similarity between the one or more feature vectors;
determining a plurality of edges for the graph based on the telemetry indicating one or more flows between pairs of nodes of the plurality of nodes; and
generating an application dependency map based on one node of the graph.

2. The method of claim 1, further comprising:
acquiring a command string for a first process of the plurality of processes; and
extracting, from the command string, one or more features of a first feature vector of the one or more feature vectors.

3. The method of claim 2, further comprising:
determining one or more tokens from the command string;
determining a MIME type for the one or more tokens; and
extracting a first feature of the first feature vector based on determining that a first MIME type of a first token of the one or more tokens is a binary file.

4. The method of claim 3, further comprising:
filtering out at least one of a portion of a file system path or a version number from the first feature vector.

5. The method of claim 1, further comprising:
determining a first node of the plurality of nodes by concatenating server data for a first server of the plurality of servers and process data for a first process executing on the first server.

6. The method of claim 1, wherein the graph is at least one of a dendrogram or a tree.

7. The method of claim 6, further comprising:
determining one or more first nodes of a first hierarchical level of the graph based at least in part on a first measure of similarity between one or more first feature vectors of the one or more first nodes; and
determining one or more second nodes of a second hierarchical level of the graph based at least in part on a second measure of similarity, different from the first measure of similarity, between one or more second feature vectors of the one or more second nodes.

8. The method of claim 7, further comprising:
determining the first hierarchical level based at least in part on a first measure of centrality; and
determining the second hierarchical level based at least in part on a second measure of centrality different from the first measure of centrality.

9. The method of claim 7, further comprising:
determining the first hierarchical level based at least in part on a first measure of cluster quality; and
determining the second hierarchical level based at least in part on a second measure of cluster quality different from the first measure of cluster quality.

10. The method of claim 1, further comprising:
displaying the graph;
receiving a selection of a first node of the plurality of nodes;
determining a second plurality of nodes for a second graph based at least in part on second measures of similarity between the one or more feature vectors of the second plurality of nodes;
determining a second plurality of edges for the second graph based at least in part on the telemetry indicating one or more second flows between second pairs of nodes of the second plurality of nodes; and
displaying the second graph.

11. The method of claim 10, further comprising:
receiving a second selection of the second pair of nodes; and
displaying a first feature vector of at least one node of the second pair of nodes.

12. The method of claim 1, further comprising:
generating one or more policies based at least in part on the application dependency map.

13. A system comprising:
a processor; and
memory including instructions that, upon being executed by the processor, cause the system to:
capture telemetry from a plurality of servers and a plurality of network devices of a network;
determine one or more feature vectors for a plurality of processes executing in the network based on the telemetry;
determine a plurality of nodes for a graph based on measures of similarity between the one or more feature vectors;
determine a plurality of edges for the graph based on the telemetry indicating one or more flows between pairs of nodes of the plurality of nodes; and
generate an application dependency map based on one node of the graph.

14. The system of claim 13, wherein the instructions upon being executed further cause the system to:
capture at least a portion of the telemetry at line rate from a hardware sensor embedded in an application-specific integrated circuit (ASIC) of a first network device of the plurality of network devices.

15. The system of claim 13, wherein the instructions upon being executed further cause the system to:
capture at least a portion of the telemetry from a software sensor residing within a bare metal server of the network.

16. The system of claim 13, wherein the instructions upon being executed further cause the system to:
capture at least a portion of the telemetry from a plurality of software sensors residing within a plurality of virtual entities of a same physical server of the network.

17. A non-transitory computer-readable medium having instructions that, upon being executed by a processor, cause the processor to:
capture telemetry from a plurality of servers and a plurality of network devices of a network;
determine one or more feature vectors for a plurality of processes executing in the network based on the telemetry;
determine a plurality of nodes for a graph based on measures of similarity between the one or more feature vectors;
determine a plurality of edges for the graph based on the telemetry indicating one or more flows between pairs of nodes of the plurality of nodes; and
generate an application dependency map based on one node of the graph.

18. The non-transitory computer-readable medium of claim 17, wherein the graph is at least one of a host-process graph, a process graph, or a hierarchical process graph.

19. The non-transitory computer-readable medium of claim 17, wherein the instructions further cause the processor to:
display the graph;
receive a selection of a first node of the plurality of nodes;
determine a second plurality of nodes for a second graph based at least in part on second measures of similarity between the one or more feature vectors of the second plurality of nodes;
determine a second plurality of edges for the second graph based at least in part on the telemetry indicating one or more second flows between second pairs of nodes of the second plurality of nodes; and
display the second graph.

20. The non-transitory computer-readable medium of claim 19, wherein the instructions further cause the processor to:
receive a second selection of the second pair of nodes; and
display a first feature vector of at least one node of the second pairs of nodes.
